(19) United States
(12) Patent Application Publication
(10) Pub. No.: US 2018/0346172 A1
(43) Pub. Date: Dec. 6, 2018

(54) APPARATUS FOR APPLYING LEAFLETS TO CONTAINERS

(71) Applicant: P.E. LABELLERS S.P.A., Porto Mantovano (IT)

(72) Inventor: Nicola SCHINELLI, Mantova (IT)

(21) Appl. No.: 15/757,781

(22) PCT Filed: Sep. 9, 2016
(86) PCT No.: PCT/EP2016/071273

§ 371 Date: Mar. 6, 2018

(30) Foreign Application Priority Data
Sep. 11, 2015 (IT) 102015000050627

(51) Int. Cl. B65B 61/20; B65C 9/14

(52) U.S. Cl. CPC B65B 61/202; B65C 9/14

(57) ABSTRACT

An apparatus for applying leaflets to containers, which comprises a fixed framework that supports at least one magazine for containing leaflets which faces, with its outlet, the peripheral region of an application drum, which can rotate about its own axis, with respect to the fixed framework, and is provided with at least one accommodation seat for at least one respective leaflet picked up from the outlet of the magazine and intended to be transferred onto at least one respective container moved by a conveyor; the application drum can be actuated with a continuous rotary motion about its own axis and is provided, at the accommodation seat, with elements for retaining the leaflet that can be moved on command between a condition that lies close to the axis of the application drum and a condition that is spaced from the axis of the application drum.

The present invention relates to an apparatus for applying leaflets to containers.

It is known to apply to the external surface of containers of drugs or other products informational leaflets, commonly known as “outserts”, which are normally constituted by a sheet that is folded in multiple folds and bears, printed thereon, information related to the product that is present in the corresponding container.

Currently, these leaflets are applied automatically by means of apparatuses which generally have an applicator which moves intermittently in order to transfer in each instance a leaflet picked up from a corresponding magazine onto a corresponding container that arrives from an adapted conveyor.

The intermittent movement of the applicator makes these known apparatuses very slow and therefore unsuitable to be used along high-speed packaging lines.

The aim of the present invention is to provide an apparatus for applying leaflets to containers that can operate at the speeds of the most modern packaging lines.

Within this aim, an object of the present invention is to provide an apparatus for applying leaflets to containers that ensures high reliability in the operation for fixing the leaflets to the containers.

Another object of the invention is to provide an apparatus for applying leaflets to containers that has a simple structure and is competitive from an economic standpoint.

This aim, as well as these and other objects that will become better apparent hereinafter, are achieved by an apparatus for applying leaflets to containers, according to the invention, as defined in claim 1.

Further characteristics and advantages of the present invention will become better apparent from the following detailed description of a preferred but not exclusive embodiment of the apparatus according to the invention, illustrated by way of non-limiting example in the accompanying drawings, wherein:

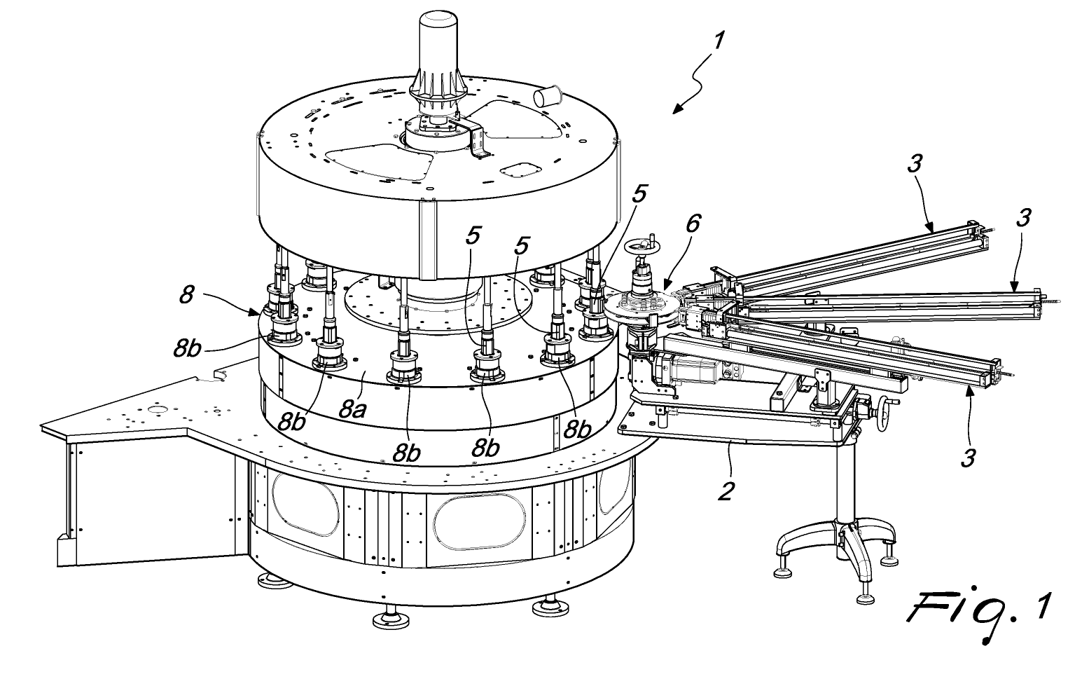

FIG. 1 is a perspective view of an apparatus according to the invention;

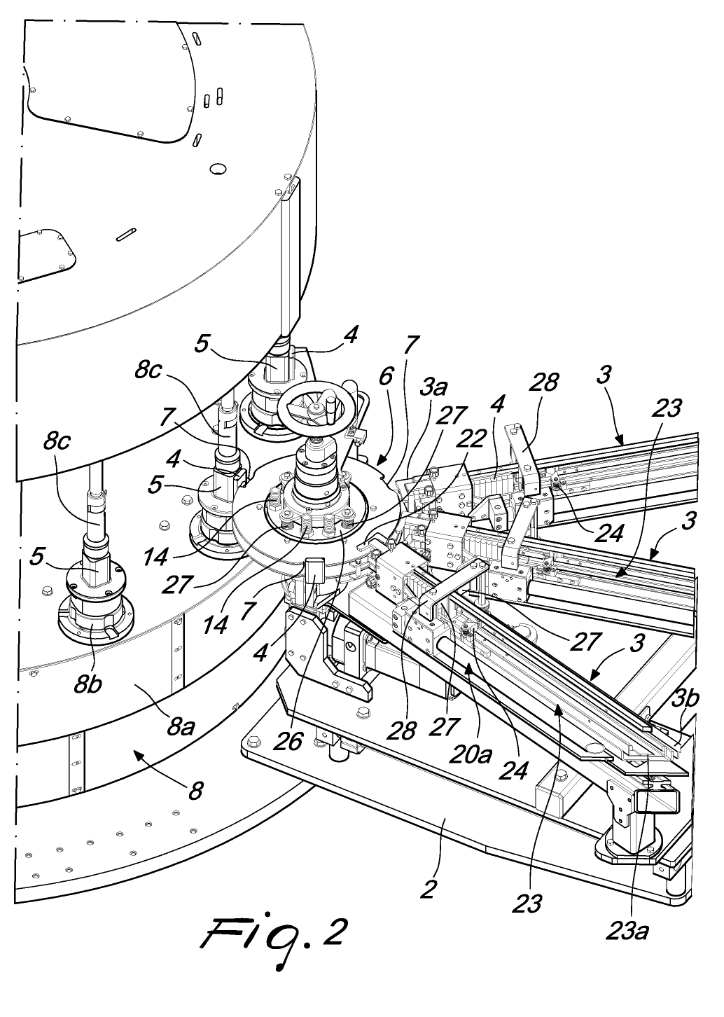

FIG. 2 is a perspective view of a detail of the apparatus according to the invention;

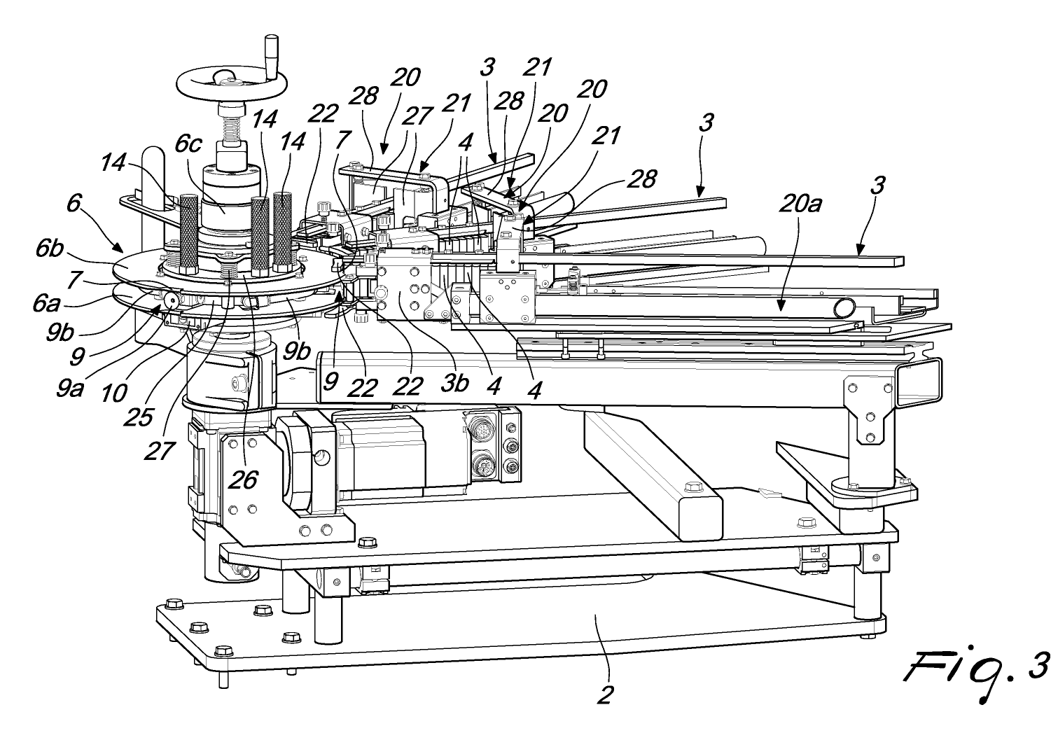

FIG. 3 is a perspective view of a portion of the apparatus according to the invention;

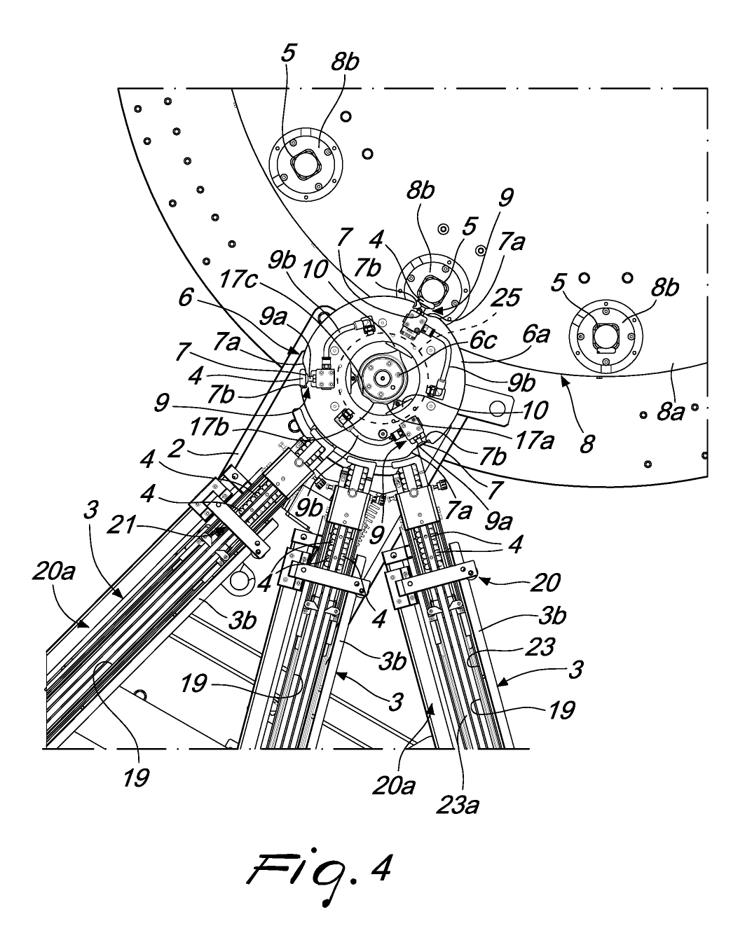

FIG. 4 is a top plan view of the apparatus according to the invention, with parts omitted for the sake of simplicity and magazines shown in the inactive position;

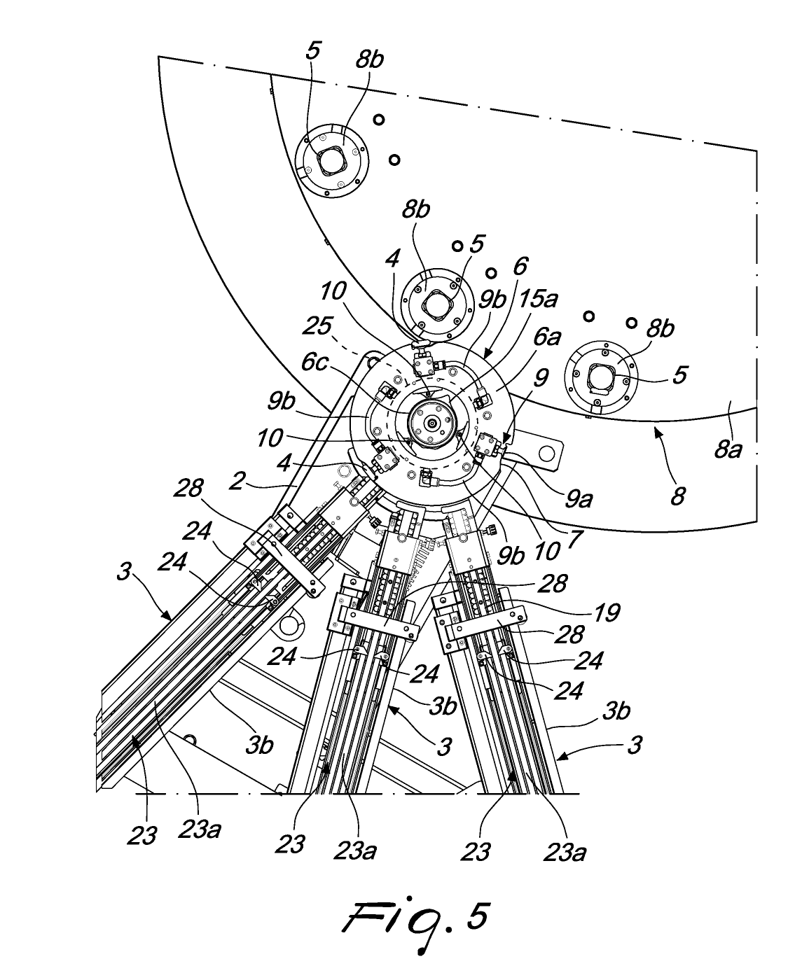

FIG. 5 is a top plan view of the apparatus according to the invention with parts omitted for the sake of simplicity and with a magazine in the active position in order to allow an application drum to pick up leaflets from it;

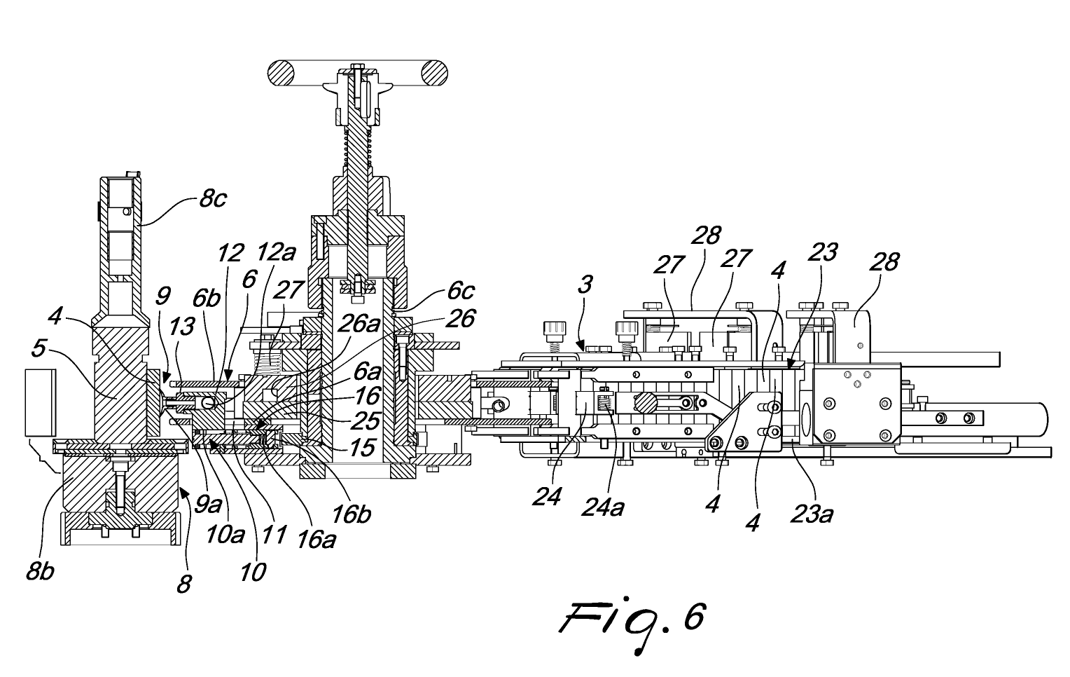

FIG. 6 is a sectional view of the apparatus according to the invention;

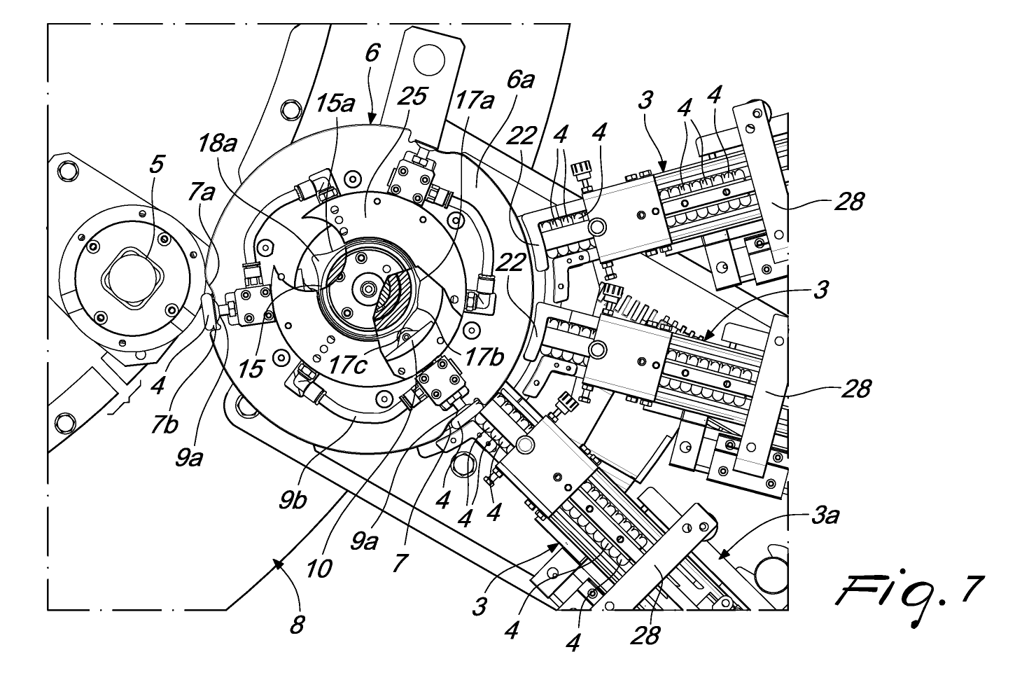

FIG. 7 is an enlarged-scale top plan view of a portion of the apparatus according to the invention with parts omitted and others shown in cutout view.

With reference to the figures, an apparatus for applying leaflets to containers, designated generally by the reference numeral 1, comprises a fixed framework 2 which supports at least one magazine 3, which is intended to contain a plurality of leaflets 4 to be applied to containers 5 and is provided with at least one outlet 3a which is arranged so as to face the peripheral region of an application drum 6, which can rotate about its own axis with respect to the fixed framework 2.

In particular, the application drum 6 has, on its peripheral region, at least one accommodation seat 7 that is intended to receive at least one respective leaflet 4 picked up at the outlet 3a of the magazine 3 and meant to be transferred onto at least one respective container 5 moved by a conveyor 8, which is arranged laterally adjacent to the application drum 6 and is constituted for example by a carousel 8a provided conveniently with pans 8b on which individual containers 5 are rested and, optionally, with locking elements 8c for the containers 5, each arranged above a respective pan 8b in order to clamp a corresponding container 5.

According to the invention, the application drum 6 can be actuated with a continuous rotary motion about its own axis and is provided, at the accommodation seat 7, with means 9 for retaining the leaflets 4 picked up from the magazine 3.

Also according to the invention, the means 9 for retaining the leaflets 4 can be moved on command between a condition that lies close to the axis of the application drum 6, in order to allow the installation of the leaflets 4 in the accommodation seat 7, and at least one condition that is spaced from the axis of the application drum 6 in order to pick up the leaflets from the outlet 3a of the magazine 3 and transfer the leaflets 4 onto the respective container 5.

With reference to the embodiment shown in the figures, it is possible advantageously to provide at least two distinct magazines 3, which are arranged so as to be mutually angularly spaced around the application drum 6.

For example, as shown, there can be three distinct magazines 3, but their number can also be different according to the requirements.

Conveniently, the magazines 3 can be arranged selectively between an active position, in which they are closer, with the corresponding outlet 3a, to the peripheral region of the application drum 6, in order to allow the latter to pick up the leaflets 4 contained therein, and an inactive position, in which they are spaced, with the respective outlet 3a, from the peripheral region of the application drum 6.

Again with reference to the illustrated embodiment, at the peripheral region of the application drum 6 there is conveniently a plurality of accommodation seats 7, which are distributed so as to be mutually spaced around the axis of the application drum 6 and are intended to each receive a respective leaflet 4, which is picked up at the outlet 3a of the magazines 3. In this case, respective retention means 9 are provided at each one of the accommodation seats 7.

In greater detail, each accommodation seat 7 conveniently has, at a front end, along the direction of rotation of the application drum 6, a guiding portion 7a that is inclined progressively toward the axis of the application drum 6 as one proceeds toward the rear end of the accommodation seat 7, so as to facilitate the entry of the leaflets 4 in the accommodation seats 7.

Advantageously, at its rear end, each accommodation seat 7 has an abutment portion 7b that is extended substantially at right angles to the axis of the application drum 6 in order to allow traction of the leaflets 4 by the application drum 6 in its rotation about its own axis.

Conveniently, the application drum 6 has a base body that is mounted so that it can rotate with respect to the fixed framework 2.

Advantageously, the retention means 9 of each accommodation seat 7 are supported by a respective carriage 10, which is located at the corresponding accommodation seat 7 and is mounted on the base body of the application drum 6 so that it can move along a direction that is substantially perpendicular to the axis of said application drum.

Advantageously, the retention means 9 can be constituted by at least one respective suction device, constituted conveniently by at least one respective sucker 9a which is connected to respective vacuum creation means, which are constituted for example by a vacuum pump or other similar device, not shown, by means of a corresponding suction duct 9b.

In greater detail, the base body of the application drum 6 can, for example, be constituted by a pair of plates 6a and 6b which face each other, are substantially annular and are arranged around a central body 6c, which is coaxial to the axis of the application drum 6. Conveniently, each carriage 10 is mounted so that it can slide on linear guides 10a which extend radially with respect to the axis of the application drum 6 and are formed on one of the plates 6a, 6b, for example the one designated by the reference numeral 6a in the drawings.

In particular, the carriages 10 and the corresponding linear guides 10a are arranged on the face of the plate 6a that is directed in the opposite direction with respect to the other plate 6b.

Conveniently, each carriage 10 is connected, by means of a respective slot 11 formed in the plate 6a, to a corresponding block 12, which is arranged between the plates 6a and 6b and on which the corresponding sucker 9a is mounted.

In particular, each block 12 forms internally a suction chamber 12a, which is connected to the corresponding sucker 9a, for example by means of a connecting nipple 13, and to the respective vacuum creation means, by means of the suction ducts 9b, which are arranged conveniently between the plates 6a and 6b and are connected to corresponding vacuum ports 14 arranged on the central body 6c.

Preferably, the suction ducts 9b are connected to a first vacuum distribution body 25, which is integral with the application drum 6 and is coupled to a second vacuum distribution body 26, which is integral with the central body 6c. In particular, the first vacuum distribution body 25 has, at each suction duct 9b, a respective passage opening intended to be connected to a corresponding vacuum distribution groove 26a, which is formed in the second vacuum distribution body 26, which is connected to a corresponding vacuum port 14 and is extended along a circular arc which is extended conveniently at least for the portion of path of the application drum 6 in which the intervention of the corresponding sucker 9a is required.

Advantageously, the second vacuum distribution body 26 is made of plastic material and is conveniently kept in hermetic contact against the first vacuum distribution body 25 by way of pusher springs 27.

Advantageously, the movement of the carriages 10 along the respective linear guides 10a is provided by providing at least one contoured body 15, which is integral with the fixed framework 2 and in particular is fixed for example to the central body 6c and is provided with a cam-like profile 15a which is extended around the axis of the application drum 6 and is engaged slidingly by the carriages 10 in their movement integrally with the application drum 6.

In particular, the sliding of the carriages 10 on the cam-like profile 15a of the contoured body 15 allows to produce the movement of the retention means 9 and more particularly of the suckers 9a supported by the carriages 10 between said closer condition and at least one condition which is spaced from the axis of the application drum 6 in contrast with, or by virtue of the action of, elastic return means 16.

For example, the elastic return means 16 comprise, for each carriage 10, at least one respective spring 16a, which acts along a direction that is substantially radial with respect to the axis of the application drum 6, between the corresponding carriage 10 and a corresponding abutment 16b that is integral with the base body of the application drum 6 and in particular, according to the illustrated example, with the plate 6a.

Conveniently, the cam-like profile 15a has variations in the distance from the axis of the application drum 6 substantially at the angular position in which the magazines 3 are located with respect to the axis of the application drum and the conveyor 8, or, more conveniently, in a position that is slightly upstream with respect to the angular position of the magazines 3 along the direction of rotation of the application drum 6.

According to the illustrated embodiment, these distance variations comprise first protrusions 17a, 17b, 17c, which are arranged at the magazines 3 and protrude, with respect to the remaining part of the contoured body 15, in the direction of the peripheral region of the application drum 6, and at least one second protrusion 18a, which is arranged at the conveyor 8 and protrudes more than the first protrusions 17a, 17b and 17c, so that the engagement of the carriages 10 with the second protrusion 18a can cause a greater spacing of the retention means 9 from the axis of the application drum 6 with respect to the situation in which the carriages engage the first protrusions 17a, 17b, 17c.

Conveniently, each one of the magazines 3 has at least one respective containment chamber 19 for a plurality of leaflets 4 to be applied and feeder means which allow to arrange one leaflet 4 at a time at the respective outlet 3a.

In greater detail, the containment chamber 19 of each magazine 3 is extended conveniently along a direction that is substantially radial with respect to the axis of the application drum 6 and it is possible to insert therein the leaflets 4 to be applied, one next to the other.

In particular, the outlet 3a of the magazines 3 is arranged at the end that is directed toward the application drum 6 of the corresponding containment chamber 19.

Each one of the magazines 3 can translate selectively with respect to the fixed framework 2 along a direction that is substantially perpendicular to the axis of the application drum, so as to be able to pass from the inactive position to the active position and vice versa.

More particularly, each magazine 3 conveniently has a frame 3b with an elongated extension that forms internally the containment chamber 19 and can slide axially, with respect to the fixed framework 2, between said inactive position and said active position of the magazine 3.

The feeder means of each magazine 3 are constituted by respective pushers 20, preferably constituted by linear actuation means 20a, conveniently provided by at least one respective piston with magnetic rings, which act on pusher elements 21 intended to rest against the row of leaflets 4 inserted in the corresponding containment chambers 19 so as to push them toward the corresponding outlet 3a.

Conveniently, the magazines 3 have, at the corresponding outlets 3a, means for blocking the leaflets 4, which are constituted for example by a pair of abutment retainers 22, which are mutually opposite and face the corresponding outlet 3a and against which the first leaflet 4 that is present at the outlet 3a of the magazines 3 rests when the magazines are in the inactive position.

The abutment retainers 22 are conveniently mutually spaced along a direction that is substantially parallel to the axis of the application drum 6. In particular, the distance between the abutment retainers 22 is advantageously greater than the dimension in the axial direction of the application drum 6.

With the magazines 3 in the active position, the abutment retainers 22 are arranged beyond the edge of the application drum 6, toward the axis thereof, and the leaflet 4 that in each instance is located at the outlet 3a makes contact with the peripheral region of the application drum 6 and more particularly with the perimetric edge of the plates 6a and 6b, waiting to be picked up by one of the accommodation seats 7 of the application drum 6 and by the corresponding retention means 9. In practice, with the magazines 3 in the active position, the leaflet 4 that is at the outlet 3a of the corresponding magazine is no longer blocked, in its advancement under the thrust of the pushers 20, by contact against the abutment retainers 22 but by contact against the edge of the application drum 6, ready to be pulled by the application drum 6 upon the arrival of one of the accommodation seats 7.

Advantageously, inside the containment chamber 19 formed by the frame 3b of each magazine 3 it is possible to insert axially a holder 23 of new leaflets 4, which allows rapid filling of the magazines 3 when the leaflets 4 contained therein are being depleted or are completely depleted.

Each holder 23 comprises a slider 23a which supports a row of new leaflets 4 to be loaded into the corresponding magazine 3 and can be made to slide within the containment chamber 19 of the magazine 3 to be reloaded, inserting it from the end of the containment chamber 19 that is opposite to the one in which the outlet 3a of the magazine is formed, until the leaflets 4 of the holder 23 are brought against any leaflets 4 remaining within the magazine 3.

Conveniently, at the end of each magazine 3 intended to be directed toward the outlet 3a of the magazine 3 there is an exit opening for the leaflets 4 carried by the magazine 3, in which there are means for blocking the leaflets 4 in the magazine 3 which are capable of deactivating automatically when the leaflets 4 of the magazine 3 are pushed by the pusher 20 of the magazine 3 toward the outlet 3a thereof.

The blocking means are constituted for example by a pair of blocking levers 24, which are supported by the slider 23a of the holder 23 and are arranged on mutually opposite sides with respect to the exit opening of the holder 23 and can oscillate in contrast with elastic return springs 24a between a closed condition, in which they prevent the exit of the leaflets 4 from the corresponding holder 23, and an open condition, which is assumed under the thrust received by the leaflets 4 of the holder 23, in the direction of the outlet 3a of the magazine, as a consequence of the actuation of the pusher 20 of the magazine 3, in which they allow the crossing of the exit opening of the holder 23 by the leaflets 4 inserted inside it.

Conveniently, the pusher elements 21 of the pushers 20 of the magazines 3 are constituted by a pair of rotatable flaps 27, which are mutually opposite and are supported by a sliding element 28, which can be actuated for translation by the linear actuation means 20a along the axis of the containment chamber 19 of the corresponding magazine 3 both in the direction of the outlet 3a of the magazine 3 and in the opposite direction.

In particular, the rotatable flaps 27 can pass, in contrast with elastic return means, from an engagement position, in which they are capable of engaging the rear end of the row of leaflets 4 that is directed in the opposite direction with respect to the outlet 3a of the magazine 3, to a disengaged condition, which they assume automatically when the corresponding sliding element 28 is made to retract by the linear actuation means 20a in the opposite direction with respect to the outlet 3a of the magazine 3, after a new holder 23 of leaflets 4 has been inserted behind the sliding element 28 so as to allow the sliding element 28 to reach and move beyond the rear end of the row of leaflets 4 that are present in the inserted holder 23.

Conveniently, glue application means, not shown, are also provided which allow to deposit on the leaflets 4 picked up by the application drum or directly on the containers 5 a layer of glue which allows the adhesion of the leaflets 4 to the containers 5.

Operation of the apparatus according to the invention is as follows.

One of the magazines 3, loaded with the leaflets 4 to be applied, is arranged in the active position and the application drum 6 is actuated with a continuous rotary motion about its own axis.

The leaflet 4 that is located at the outlet 3a of the magazine 3 arranged in the active position, free from the engagement of the abutment retainers 22, is pushed by the pusher 20 of the corresponding magazine 3 against the peripheral region of the application drum 6, waiting for the arrival of an accommodation seat 7.

As soon as an accommodation seat 7 reaches the position in which the magazine 3 is located in the active position, the leaflet 4 that is located at the outlet 3a of the magazine 3 begins to engage the guiding portion 7a of the incoming accommodation seat 7, so as to progressively enter it.

In the meantime, the carriages 10, pulled by the base body of the application drum 6 in its rotary motion about its own axis, slide on the cam-like profile 15a of the contoured body 15 and undergo, at the first protrusions 17a, 17b, 17c, a translation in a radial direction, in contrast with the action of the corresponding spring 16a, so as to move the corresponding sucker 9a from a closer condition to a spaced condition with respect to the axis of the application drum 6.

In this manner, the suckers 9a of the carriages 10, also by way of the action of the vacuum creation means connected thereto, can make contact with and adhere perfectly to the leaflet 4 that is located at the outlet 3a of the magazine 3 that is arranged in the active position and which, as a consequence of its sliding along the guiding portion 7a, has progressively entered the accommodation seat 7 that has reached its position.

As soon as the carriages 10 abandon the first protrusion that is located at the magazine 3 arranged in the active position, they are returned by the action of the spring 16a to a condition that lies closer to the axis of the application drum.

In this manner, the installation in the accommodation seat 7 of the picked up leaflet 4 is also completed, and said leaflet is thus retained by the corresponding sucker 9a adjacent to the bottom of the accommodation seat 7 and is therefore pulled in the rotation of the application drum 6 by its resting contact against the abutment portion 7b.

Continuing in the rotation of the application drum 6, the accommodation seat 7 with the picked up leaflet 4 inside it reaches the position of the conveyor 8 of the containers 5.

At this point, the corresponding carriage 10 engages the second protrusion 18a of the contoured body 15, thus undergoing a displacement from the closer condition to a spaced condition with respect to the axis of the application drum 6.

In this manner, the leaflet 4 arranged in the accommodation seat 7 is moved into contact with and pressed against a container 5 that is arriving on the conveyor 8 and subsequently the vacuum creation means connected to the corresponding sucker 9a are deactivated, so that the sucker 9a can detach from the leaflet 4.

In particular, the deactivation of the vacuum creation means is achieved because the passage opening of the first vacuum distribution body 25 connected to the sucker 9a has moved beyond the corresponding vacuum distribution groove 26a formed in the second vacuum distribution body 26.

Thanks to a layer of glue applied previously to the leaflet 4 or to the container 5 by adapted application means, the leaflet 4 can therefore adhere perfectly to the container 5 and be transferred onto it.

The continuation of the rotation of the application drum 6 about its own axis causes the disengagement of the carriage 10 from the second protrusion 18a and its return to the condition that lies closer to the axis of the application drum 6 by way of the action of the corresponding spring 16a.

At this point, the vacuum creation means connected to the sucker 9a supported by the carriage 10 that has returned to the condition that lies closer to the application drum 6 are reactivated so as to prepare themselves to pick up a new leaflet 4. This reactivation is achieved by virtue of the new reaching of the corresponding vacuum distribution groove 26a that is formed in the second vacuum distribution body 26 by the passage opening provided in the first vacuum distribution body 25 and connected to the sucker 9a, during the rotation of the application drum 6 about its own axis.

When all the leaflets 4 of the magazine 3 in the active position have been picked up, another magazine 3, filled with leaflets 4, is moved to the active position and the empty one is returned to the inactive position so that it can be reloaded with new leaflets, without loss of production, by using a full holder 23.

In practice it has been found that the invention is capable of achieving fully the intended aim and objects.

All the characteristics of the invention indicated above as advantageous, convenient or the like may also be omitted or be replaced with equivalents.

The individual characteristics described with reference to general teachings or particular embodiments may all be present in other embodiments or may replace characteristics in these embodiments.

The invention thus conceived is susceptible of numerous modifications and variations, all of which are within the scope of the appended claims.

In practice, the materials used, so long as they are compatible with the specific use, as well as the dimensions and shapes, may be any according to requirements.

All the details may further be replaced with other technically equivalent elements.

The disclosures in Italian Patent Application No. 102015000050627 (UB2015A003559) from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-11. (canceled)

12. An apparatus for applying leaflets to containers, comprising a fixed framework supporting at least one magazine adapted to contain a plurality of leaflets and having at least one outlet for said leaflets that is arranged so as to face a peripheral region of an application drum, which can rotate about its own axis, with respect to said fixed framework, and having, on its own peripheral region, at least one accommodation seat for at least one respective leaflet picked up from said outlet and intended to be transferred onto at least one respective container moved by a conveyor, wherein said application drum can be actuated with a continuous rotary motion about its own axis and is provided, at said at least one accommodation seat, with retention means for retention of said at least one leaflet that can be moved on command between a condition that lies close to the axis of said application drum, in order to allow the installation of said at least one leaflet in said at least one accommodation seat, and a condition that is spaced from the axis of said application drum, in order to pick up said at least one leaflet from said outlet and to transfer said at least one leaflet onto the respective container.

13. The apparatus according to claim 12, wherein said at least one accommodation seat has, at a front end thereof according to the rotation direction of said application drum, a guiding portion that is inclined progressively toward the axis of said application drum, in order to allow the entry of said at least one leaflet in said at least one accommodation seat, and, at its rear end, an abutment portion that is extended substantially at right angles to the axis of said application drum in order to allow traction of said at least one leaflet by said application drum in its rotation about its own axis.

14. The apparatus according to claim 12, wherein said application drum has a base body that can rotate about its own axis with respect to said fixed framework, said retention means being supported by a respective carriage, arranged at said at least one accommodation seat and mounted so that it can move on said base body of said application drum along a direction that is substantially perpendicular to the axis of said application drum.

15. The apparatus according to claim 12, wherein said retention means comprise at least one suction device.

16. The apparatus according to claim 15, wherein said at least one suction device comprises at least one sucker connected to means for creating vacuum.

17. The apparatus according to claim 14, comprising at least one contoured body with a cam-like profile that is extended around the axis of said application drum and is engaged slidingly by said carriage in its movement integrally with said application drum, in order to cause the movement of said retention means between said closer condition and said spaced condition in contrast with, or by the action of, elastic return means.

18. The apparatus according to claim 12, further comprising, at the peripheral region of said application drum, a plurality of accommodation seats distributed around the axis of said application drum and intended to receive each a respective leaflet picked up at said at least one outlet of said at least one magazine, respective retention means being provided at each one of said accommodation seats.

19. The apparatus according to claim 12, comprising at least two magazines that are mutually arranged so as to be angularly spaced around said application drum.

20. The apparatus according to claim 19, wherein said magazines can be arranged selectively between an active position, in which they are closer, with their outlet, to the peripheral region of said application drum, and an inactive position, in which they are spaced, with the respective said outlet, from the peripheral region of said application drum.

21. The apparatus according to claim 19, wherein each one of said magazines has at least one respective chamber for containing a plurality of leaflets to be applied and means for feeding a leaflet at a time at the respective outlet of said magazines.

22. The apparatus according to claim 17, wherein said cam-like profile has variations in its distance from the axis of said application drum that are substantially at the angular position of said magazines and of said conveyor with respect to the axis of said application drum.

23. An apparatus for applying leaflets to containers, comprising: a framework supporting a magazine adapted to contain a plurality of leaflets and having a leaflet outlet that faces a peripheral region of an application drum, wherein the application drum is rotatable about a drum axis such that the peripheral region of the application drum moves past the leaflet outlet during rotation of the application drum, wherein the peripheral region of the application drum includes a leaflet accommodation seat for picking up at least one leaflet from the leaflet outlet for subsequent transferral onto a container moved by a conveyor, wherein the application drum can be actuated with a continuous rotary motion about the drum axis, wherein the leaflet accommodation seat includes retention means for retention of the at least one leaflet, wherein the retention means can be selectively moved between a first condition and a second condition, wherein the first condition is nearer to the drum axis than said second condition, wherein the first condition allows installation of the at least one leaflet in the leaflet accommodation seat, and the second condition enables pick up of the at least one leaflet from the leaflet outlet and transfer of the at least one leaflet onto the container.

24. The apparatus according to claim 23, wherein the leaflet accommodation seat has a front end and a rear end, in each case according to a rotation direction of the application drum, the front end having a guiding portion that is inclined progressively toward the drum axis in order to allow entry of the at least one leaflet in the leaflet accommodation seat, the rear end having an abutment portion that allows traction of the at least one leaflet by the application drum during rotation about the drum axis.

25. The apparatus according to claim 23, wherein the application drum has a base body, the retention means is supported by a carriage positioned at the accommodation seat and mounted so that the carriage can move on the base body along a direction that is substantially perpendicular to the drum axis.

26. The apparatus according to claim 23, wherein the retention means comprises at least one suction device.

27. The apparatus according to claim 26, wherein the at least one suction device comprises at least one sucker connected to means for creating vacuum.

28. The apparatus according to claim 25, further comprising a contoured body with a cam profile that extends around the drum axis and slidingly engages the carriage as the carriage rotates with the application drum in order to cause movement of the retention means between said first condition and said second condition in contrast with, or by the action of, elastic return means.

29. The apparatus according to claim 28, wherein the magazine is a first magazine and a second magazine is also provided and is angularly spaced from the first magazine about the application drum.

30. The apparatus according to claim 29, wherein each of the first magazine and the second magazine can be arranged selectively between an active position and an inactive position, when in the active position the leaflet outlet is closer to the peripheral region of the application drum than when in the inactive position.

31. The apparatus according to claim 29, wherein the cam-like profile has first and second protruding profile parts that are angularly offset from each other, and an angular spacing between the first protruding profile part and the second protruding profile part is substantially the same as an angular spacing between the first magazine and the second magazine, in each case relative to the drum axis.

32. An apparatus for applying leaflets to containers, comprising: a framework, an application drum and a conveyor, the framework supporting a magazine adapted to contain a plurality of leaflets and having a leaflet outlet that faces a peripheral region of the application drum, wherein the application drum is rotatable about a drum axis such that the peripheral region of the application drum moves past the leaflet outlet during rotation of the application drum, wherein the peripheral region of the application drum includes a leaflet accommodation seat for picking up at least one leaflet from the leaflet outlet for subsequent transferral onto a container moved by the conveyor, wherein the leaflet accommodation seat includes a suction device for retention of the at least one leaflet in the leaflet accommodation seat, wherein the suction device is automatically moved between a first position and a second position during rotation of the application drum, wherein the first position is nearer to the drum axis than the second position, wherein the suction device is moved to the second position in order to pick up the at least one leaflet from the leaflet outlet and in order to transfer the at least one leaflet onto the container, and the suction device is moved to the first position during rotational movement of the at least one leaflet from the leaflet outlet to the conveyor.
